(19) United States
(12) Patent Application Publication
(10) Pub. No.: US 2012/0072848 A1
(43) Pub. Date: Mar. 22, 2012

(54) SYSTEM AND METHOD FOR SOCIAL COLLECTION

(75) Inventor: ANDREW YONEMOTO, San Jose, CA (US)

(73) Assignee: Sony Corporation, Tokyo (JP)

(21) Appl. No.: 12/886,390

(22) Filed: Sep. 20, 2010

(51) Int. Cl. G06F 3/00

(52) U.S. Cl. 715/744

(57) ABSTRACT

Methods and apparatus are provided for establishing a network addressable collection of one or more media files based on a social connection. In one embodiment, a method includes receiving a request from a user to establish a collection associated with an event, wherein the collection relates to a network addressable site configured to provide a user interface for content provided by the user, and receiving content from the user to be stored with the collection. The method may further include receiving identification information from the user for one or more participant users, and transmitting a notification to the one or more participant users, wherein the notification includes a graphical display including a graphical representation of the content stored in the collection.

### FIELD

The present patent document relates generally to content sharing, and more particularly to a system and method for establishing a network addressable collection of media files based on a social collection.

### BACKGROUND

Network based applications provide many services, including media sharing, social networking, entertainment, etc. One benefit of network based applications is the ability to share content. For example, electronic mail (e.g., email, etc.) allow for content to be distributed to one or more recipients. This type or network communication however, is limited in allowing for content to be modified and/or added to the message once it has been sent. By way of further example, many social networking sites allow users to share content with other members of the social networking site. One of the drawbacks of these conventional applications is the inability to share content with non-members of the networking site. Similarly, it may be difficult to share content with others that use a different social networking application. Further, while allowing content to be uploaded to a social networking site, these conventional applications are directed to managing a following or list of associates. Many consumers desire an application that allows for content sharing which avoids one or more of the aforementioned drawbacks.

### SUMMARY OF THE EMBODIMENTS

Disclosed and claimed herein are methods and apparatus for establishing a network addressable collection of one or more media files based on a social connection. In one embodiment, a method includes receiving, by a server, a request from a user to establish a collection associated with an event, wherein the collection relates to a network addressable site configured to provide a user interface for content provided by the user. The method further includes receiving, by the server, content from the user to be stored with the collection, receiving identification information from the user for one or more participant users, and transmitting a notification to the one or more participant users, wherein the notification includes a graphical display including a graphical representation of the content stored in the collection.

Other aspects, features, and techniques of the patent document will be apparent to one skilled in the relevant art in view of the following detailed description of the patent document.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram according to one embodiment;

FIG. 2 depicts a process for establishing a network addressable collection of media files according to one embodiment;

FIG. 3 depicts a simplified block diagram of a device according to one embodiment;

FIG. 4 depicts a process for providing media to a collection by the device of FIG. 3 according to one embodiment;

FIG. 5 depicts a graphical representation of a user interface of a collection application according to one or more embodiments; and

FIG. 6 depicts a graphical representation of a user interface of a social collection application according to another embodiment.

### DETAILED DESCRIPTION OF THE EMBODIMENTS

### Overview and Terminology

One embodiment relates to collecting content associated with one or more users. In one embodiment, a system and methods are provided to allow a user to generate a collection. As used herein, a collection may relate to a network addressable site configured to provide a user interface for content. Each collection may be associated with a server, wherein the server allows for management, modification and establishment of one or more collections. A collection may be established by a user based on one or more social connections, and thus, may relate to a social collection application. The user may specify participants, or participant users, of the collection and one or more settings of the collection to control access to and the type of contributions by participants. According to another embodiment, collections may be event based, wherein content associated with a collection may be based on a particular event which one or more participants may have attended or are associated with.

One advantage of the systems and methods described herein may be that users and/or participants are not required to become members of the particular social networking application, or service. As such, users may share and modify content without requiring membership to a particular networking site, such as a social networking service.

In one embodiment a system may be provided that allows a user to establish, manage and access a collection. The system may further allow for other users (e.g., participants invited by the user) to access and modify a collection. The collection may be associated with a network addressable site. However, in other embodiments, the system may include a server configured to distribute a graphical user interface to one or more participants via a notification to a device (e.g., email, electronic communication in general).

According to another embodiment, one or more processes are provided for establishing, accessing and managing a collection. A process may be provided for establishing a collection by a server based on user input data. According to another embodiment, a process may be provided for a user to establish a collection via a device executing a collection application.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the disclosure is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the disclosure are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

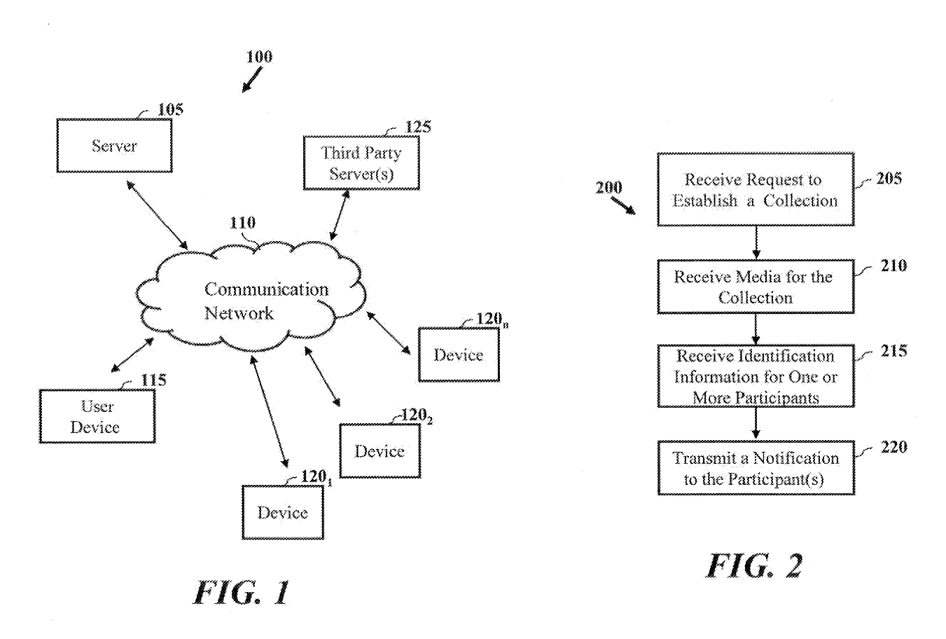

Referring now to the figures, FIG. 1 depicts a simplified system diagram according to one or more embodiments. In one embodiment, system 100 may be configured for generating, managing, maintaining, and distributing data associated with a collection. As depicted in FIG. 1, system 100 includes server 105, communication network 110, and user device 115.

Server 105 may be configured to generate and provide one or more network addressable collections. For example, one or more collections may generated for a user by server 105. In one embodiment, server 105 may be configured to host an application for generating collection data. According to another embodiment, a user employing user device 115 may be configured to provide data to server 105 based on the collection application. In certain embodiments, user device 115 may be configured to store and execute a collection application. Communication network 110 may allow for one or more of wired and wireless communication. For example, communication network may allow for network based communications including but not limited to LAN, WAN, WI-FI, etc.

User device 115 may relate to personal computer or device in general configured to execute an application and communicate via communication network 110. In one embodiment, user device 115 may include or be configured to receive content from a user, such as one or more of image data, audio data, video data, playlist data, electronic-book data and media data in general.

As depicted in FIG. 1, system 100 may include a plurality of devices 120₁₋ₙ. Devices 120₁₋ₙ may relate to devices associate with one or more participants of a collection. As will be discussed in more detail with respect to FIG. 2 below, server 105 may be configured to transmit a notification to one or more participants associated with devices 120₁₋ₙ. In certain embodiments, server 105 may be configured to transmit data associated with a collection to devices 120₁₋ₙ.

According to another embodiment, system 100 may employ one or more third party servers depicted as 125. Third party servers 125 may be configured to host a collection application and further mange and distribute data associated with one or more collections. Third party servers 125 may relate to cloud computing servers according to another embodiment.

Referring now to FIG. 2, a process is depicted for establishing a network addressable collection of one or more media files based on a social connection according to one or more embodiments. Process 200 may be employed by the server of FIG. 1 to establish a collection. Process 200 may be initiated by a server receiving a request from a user to establish a collection associated with an event at block 205. According to one embodiment the collection may relate to a network addressable site configured to provide a user interface for content provided by the user. The request may be generated by an application of a device associated with the user. The collection may be established for storing content associated with the user and/or one or more participants selected by the user. In one embodiment, participants may be associated with the user based on a social connection.

At block 210, the server may receive content from the user to be stored with the collection. Content stored by the server for the collection may be associated with one or more events. The content may relate to one or more of image data, video data, audio data, electronic-book data, playlist data, and media data in general.

A block 215, the server may receive identification information from the user for one or more participant users. Identification information may relate to an electronic address of the one or more participant users. One or more participant users may be selected by the user based on one or more of a social connection with the user and presence at an event. Process 200 may continue with the server transmitting a notification to the one or more participant users at block 220. The notification may include a graphical display including a graphical representation of the content stored in the collection. According to another embodiment, the notification may be transmitted to the one or more participant users based on the identification information. A notification may relate to an electronic transmission such as email, and/or notification configured to launch a network addressable site on a user device.

Although not depicted in FIG. 2, it may be appreciated that process 200 may include receiving additional content from the user. Based on additional content that may be received, The server may transmit a new notification to the one or more participant users identifying the additional content. Further, the server may be configured to receive content from a participant user for storage with the collection. The participant data may additionally be transmitted to one or more devices associated with the collection.

Although, process 200 has been described above with reference to establishing a collection, it should be appreciated that other types of data and or files may be managed by a server based on process 200. For example, process 200 may similarly be employed by other devices.

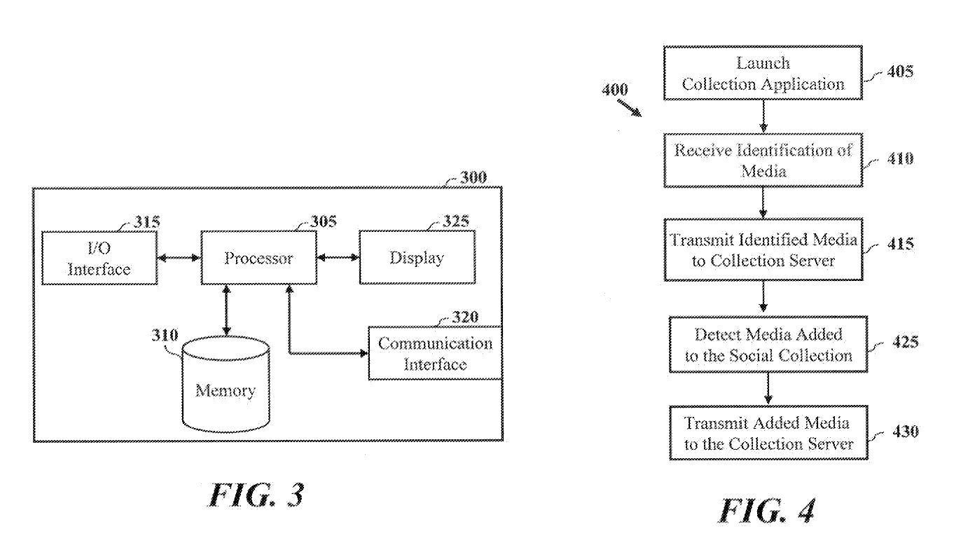

FIG. 3 depicts a simplified block diagram of a device according to one embodiment. In one embodiment, device 300 relates to the user device of FIG. 1. Device 300 may relate to a user device (e.g., user device 115), and may be configured to output audio and/or video, including data associated with a collection. According to another embodiment, device 300 may execute a collection application that may be employed by a user to provide one or more media files to a server (e.g., server 105) and view a user interface associated with one or more collections. Device 300 may relate to a personal computing device. According to another embodiment, device 300 may relate to one of an imaging device, personal communication device, electronic-reader, media player, and media device in general. When device 300 runs a collection application, it may be configured to recognize a users social network based on electronic addresses (e.g., email, etc.) associated with the users social connections. According to another embodiment, participants may be identified based on identification numbers assigned to a device configured to access the collection.

As depicted in FIG. 3, device 300 includes processor 305, memory 310, input/output (I/O) interface 315, network communication interface 320 and display 325. Processor 305 may be configured to control operation of device 300 based on one or more computer executable instructions stored in memory 310. Memory 310 may relate to one of RAM and ROM memories and may be configured to store one or more media files, content, and computer executable instructions for operation of device 300. Processor 305 may additionally be configured to execute one or more applications.

I/O interface 315 may include one or more buttons for user input, such as a numerical keypad, volume control, channel control, menu controls, pointing device, track ball, mode selection buttons, and playback functionality (e.g., play, stop, pause, forward, reverse, slow motion, etc). Buttons of I/O interface 315 may include hard and soft buttons, wherein functionality of the soft buttons may be based on one or more applications running on device 300. I/O interface 315 may be configured to allow for one or more devices to communicate with device 300 via wired or wireless communication. I/O interface 315 may include one or more ports for receiving data, including ports for removable memory.

Network communication interface 320 may be configured to allow for network based communications including but not limited to LAN, WAN, Wi-Fi, etc. In one embodiment, communication interface 320 may be configured to access a collection stored by a server. Display 325 may be employed to display image and/or video data and display one or more applications executed by processor 305.

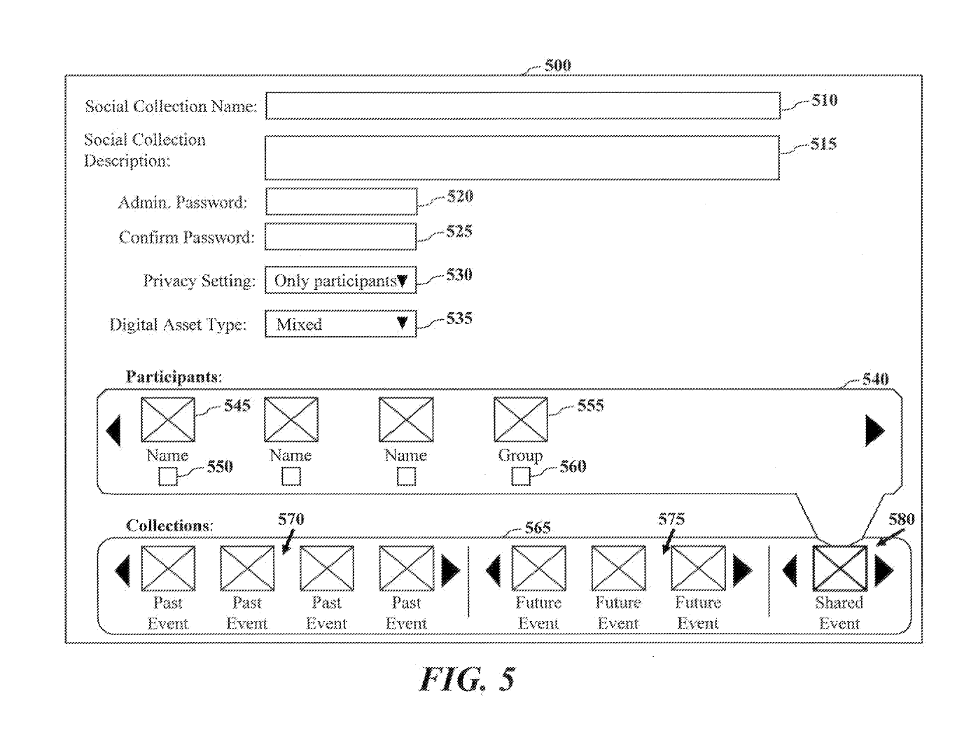

Referring now to FIG. 4, a process is depicted for providing media to a collection by the device of FIG. 3. In one embodiment, process 400 may be performed by a user device configured to communicate with a communication network (e.g., communication network 110). Process 400 may be initiated at block 405 by launch of a collection application on a user device. The collection application may result in display of a user interface as will be discussed in more detail below with respect to FIG. 5. The collection application may allow for a user to establish a collection, generate a new collection and/or add media to an established collection. In one embodiment the collection application may allow a user to select media and one or more participants for a collection. As such process 400 may allow for receiving an identification of media at block 410. In one embodiment, the user device may relate to a personal communication device, such that the identification of media may relate to media stored by the device. According to another embodiment, the identification of media may be received by the user providing a storage location of the media. The user device may then transmit the identified media to a collection server (e.g., server 105) at block 415. Process 400 may further include detecting when a user adds media to a social collection. For example, a user may add one or more media files via a user interface of the collection application on the device. The device may detect media added at block 415 and transmit the added media data to a collection server at block 430. In that fashion a user may update media associated with the collection. It should also be appreciated that process 400 may similarly be employed for detecting changes to a collection by a user on a user device.

Referring now to FIG. 5, a graphical representation is depicted of a user interface of a collection application. User interface 500 may relate to a graphical interface for establishing and/or managing a collection by a user. In one embodiment, user interface 500 may be displayed by a user device in order to generate a request for establishing a collection. User interface 500 may include a plurality of text boxes and/or drop-down menus. As depicted in FIG. 5, user interface 500 may include a text box 510 to allow a user to specify a name for the collection. Similarly, text box 515 may be employed for providing a description of the collection. In certain embodiments, a collection may be password protected. For example, modification and/or viewing of the collection may require correct entry of the password. Accordingly, user interface 500 may include text boxes 520 and 525 to allow a user to specify and confirm a collection password, respectively.

According to another embodiment, a collection may be protected by a privacy setting. For example, in one embodiment a user may set the collection as viewable and/or modifiable by only participants selected by the user. According to another embodiment, the user may set the collection as viewable publicly or only by members associated with the user via a social network. As such, drop down menu 530 may be employed to set a privacy setting of the collection. According to another embodiment, one or more media files added to the collection may be independently selected or set to have a privacy restriction. User interface 500 may additionally allow for a user to define a digital asset type of the collection. Drop down menu 535 may display a list of one or more options, including but not limited to single types of media (e.g., images, video music, etc.) and a selection of differing types of media.

According to one embodiment, user interface 500 may be employed to establish and mange one or more collections associated with a user. User interface 500 may include graphical elements of one or more collections that may have been previously established by the user. Data associated with these collections may be employed to establish a new collection, and/or to add to a collection. As depicted in FIG. 5, a user may select a particular collection which may result in the display of graphical elements, depicted as 540, for user selection. User interface 500, for example depicts selection of a shared event 580, however, it may be appreciated that selection of other collections may similarly be managed. Graphical display 540 includes graphical elements associated with one or more participants, depicted as 545 and selection boxes, depicted as 550. Participant graphical elements 545 may relate to participants associated with a user including participants within a users social network. By selecting selection box 550, the user may select a participant to be included with the collection. By un-selecting selection box 550, the user may remove the participant from the collection. Graphical display 540 may further include graphical elements for selection of a group of participants, depicted as 555, including check box 560. Group element 555 may be selected for a user to selected one or more participants assigned to the group. In certain embodiments a one or more additional group elements may be displayed in user interface 500 for a user to select. In one embodiment, graphical display may be scrollable to select other participants and/or participant groups.

According to another embodiment, user interface 500 may include a graphical display of one or more collections depicted as 565. Collections 565 may include graphical elements for past events 570, future events 575 and shared events 580. Base on user selection of a collection, user interface 500 may allow for the user to modify or delete a collection.

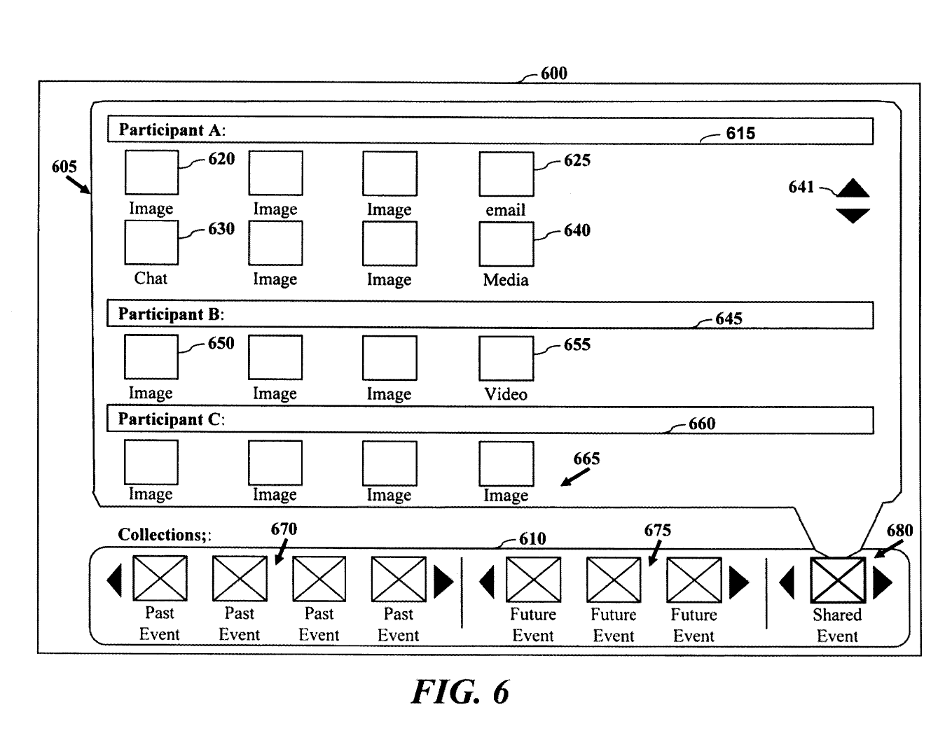

Referring now to FIG. 6, a graphical representation is depicted of a user interface of a collection application according to another embodiment. User interface 600 may relate to a graphical representation of one or more media files, participants and collections. User interface 600 may be employed for accessing data associated with a network addressable collection. In one embodiment, user 600 interface may be displayed by a device to view a collection. According to another embodiment, user interface may be transmitted to a participant for viewing a collection. It may also be appreciated that user interface 600 may allow for a user or participants to modify a collection.

As depicted in FIG. 6, user interface 600 may include graphical elements, depicted as 605, for one or more participants and content associated with each participant. Graphical elements 605 for a particular collection may be displayed. Similarly, graphical elements may be displayed for one or more collections. The collection may include one or more different types of media. For example, participant 615 may include image data 620, an email 625, chat data 630 and media in general depicted as 640. User interface 600 may include graphical elements for each of these items which a user may select. Based on user selection, user interface 600 may display the particular item. For example selection of image 620 may result in display of the image. Similarly, selection of email 625 and chat 630 may result in display of test associated with each item. Content associated with each participate may be viewed based on scroll elements shown as 641.

Content associated with other participants is depicted by 645 and 660. Participants 645 and 660 may be selected by participant 615 during establishment of the collection. Content provided by the participants may be displayed associated with each participant. For example, participant 645 includes graphical elements associated with image data 650 and video data 655. According to another embodiment, content displayed for a participant may be limited to a single media type, as shown by 665. In one embodiment, participants may be allowed to block content and/or restrict content viewing based on a collection or a specified list of participants.

User interface 600 may further include graphical elements for one or more collections associated with a user, shown as 610. For example, a user interface may display graphical elements for collections associated with past events 670, graphical elements for future events 675 and graphical elements for a shared event 680.

While this disclosure has been particularly shown and described with references to exemplary embodiments thereof, it will be understood by those skilled in the art that various changes in form and details may be made therein without departing from the scope of the disclosure encompassed by the appended claims.

What is claimed is:

1. A method for establishing a network addressable collection of one or more media files based on a social connection, the method comprising the acts of:
receiving, by a server, a request from a user to establish a collection associated with an event, wherein the collection relates to a network addressable site configured to provide a user interface for content provided by the user;
receiving, by the server, content from the user to be stored with the collection;
receiving identification information from the user for one or more participant users; and
transmitting a notification to the one or more participant users, wherein the notification includes a graphical display including a graphical representation of the content stored in the collection.

2. The method of claim 1, wherein the request is generated by an application of a device associated with the user.

3. The method of claim 1, wherein the collection is configured to store content associated with one or more participant users.

4. The method of claim 1, wherein the collection may store content associated with one or more events.

5. The method of claim 1, wherein content relates to one or more of image data, video data, audio data, electronic-book data, playlist data, and media data in general.

6. The method of claim 1, wherein the identification information relates to an electronic address of the one or more participant users, and wherein the notification is transmitted to the one or more participant users based on the identification information.

7. The method of claim 1, wherein the one or more participant users are selected based on one or more of a social connection with the user and presence at an event.

8. The method of claim 1, further comprising receiving additional content from the user, and transmit a new notification to the one or more participant users identifying the additional content.

9. The method of claim 1, further comprising receiving, by the server, content from a participant user for storage with the collection.

10. A computer program product stored on computer readable medium including computer executable code for establishing a network addressable collection of one or more media files based on a social connection, the computer program product comprising:
computer readable code to detect a user selection of an application which allows for character input by a user;
computer readable code to receive a request from a user to establish a collection associated with an event, wherein the collection relates to a network addressable site configured to provide a user interface for content provided by the user;
computer readable code to receive content from the user to be stored with the collection;
computer readable code to receive identification information from the user for one or more participant users; and
computer readable code to transmit a notification to the one or more participant users, wherein the notification includes a graphical display including a graphical representation of the content stored in the collection.

11. The computer program product of claim 10, wherein the request is generated by an application of a device associated with the user.

12. The computer program product of claim 10, wherein the collection is configured to store content associated with one or more participant users.

13. The computer program product of claim 10, wherein the collection may store content associated with one or more events.

14. The computer program product of claim 10, wherein content relates to one or more of image data, video data, audio data, electronic-book data, playlist data, and media data in general.

15. The computer program product of claim 10, wherein the identification information relates to an electronic address of the one or more participant users, and wherein the notification is transmitted to the one or more participant users based on the identification information.

16. The computer program product of claim 10, wherein the one or more participant users are selected based on one or more of a social connection with the user and presence at an event.

17. The computer program product of claim 10, further comprising computer readable code to receive additional content from the user, and transmit a new notification to the one or more participant users identifying the additional content.

18. The computer program product of claim 10, further comprising computer readable code to receive content from a participant user for storage with the collection.

19. A system comprising:
a user device; and
a server configured to establish a network addressable collection of one or more media files based on a social connection, the server configured to
receive a request from a user to establish a collection associated with an event, wherein the collection relates to a network addressable site configured to provide a user interface for content provided by the user;
receive content from the user to be stored with the collection;
receive identification information from the user for one or more participant users; and
transmit a notification to the one or more participant users, wherein the notification includes a graphical display including a graphical representation of the content stored in the collection.

20. The system of claim 19, wherein the request is generated by an application of the user device.

21. The system of claim 19, wherein the collection is configured to store content associated with one or more participant users.

22. The system of claim 19, wherein the collection may store content associated with one or more events.

23. The system of claim 19, wherein content relates to one or more of image data, video data, audio data, electronic-book data, playlist data, and media data in general.

24. The system of claim 19, wherein the identification information relates to an electronic address of the one or more participant users, and wherein the notification is transmitted to the one or more participant users based on the identification information.

25. The system of claim 19, wherein the one or more participant users are selected based on one or more of a social connection with the user and presence at an event.

26. The system of claim 19, wherein the server is further configured to receive additional content from the user, and transmit a new notification to the one or more participant users identifying the additional content.

27. The system of claim 19, wherein the server is further configured to receiving content from a participant user for storage with the collection.
